(19) United States
(12) Patent Application Publication
(10) Pub. No.: US 2016/0339574 A1
(43) Pub. Date: Nov. 24, 2016

(54) PYROTECHNIC DRIVING DEVICE

(71) Applicant: Hilti Aktiengesellschaft, Schaan (LI)

(72) Inventor: Harald Fielitz, Lindau (DE)

(21) Appl. No.: 15/113,857

(22) PCT Filed: Mar. 24, 2015
(86) PCT No.: PCT/EP2015/056240

§ 371 Date: Jul. 25, 2016

(30) Foreign Application Priority Data
Mar. 28, 2014 (EP) 14162173.0

(51) Int. Cl. B25C 1/14

(52) U.S. Cl. CPC B25C 1/143

(57) ABSTRACT

The invention relates to a driving device comprising a hand-held housing, a piston element, which is accommodated in a piston guide, for transmitting energy from a propellant charge to a fastening element to be driven in, the piston element extending along a central axis (A), and an actuator by means of which a start position of the piston element can be variably modified for changing the energy transmitted from the propellant charge to the piston element, the actuator comprising a slotted guide that has a plurality of stop positions which differ in the axial direction.

The invention relates to a driving device according to the preamble of claim 1.

Known from the prior art are manually guided driving devices with propellant charges in which, after the ignition of a pyrotechnic charge, the resulting combustion gases expand in a combustion chamber. This accelerates a piston as an energy transmission means and drives a fastening element into a workpiece.

Hilti Corporation, Schaan, Liechtenstein, sells a known pyrotechnic driving device under the DX 36 designation. In this device, the driving energy of a fastening element may be reduced when needed by controlled forward adjustment of the start position of the piston in a combustion chamber. To this end, an adjusting wheel is provided on the device and is disposed laterally offset from a central axis of the piston in a section of the device to the rear of the drive direction.

In addition, the DX 36 device is a type of drive device that does not have automatic piston return. In the DX 36 device, after a driving process, the piston is brought into a start position using a manual cocking movement. To this end, in a first phase of the cocking movement, a piston guide is moved forward in the driving direction, wherein a housing-fast stop limits the movement of the piston in the same direction. Because of this, there is a backward movement of the piston, relative to the piston guide, opposing the set direction. The piston is thus moved by the first phase of the cocking movement into a rear position in the piston guide, which corresponds to a start position with maximum driving energy.

In a second phase of the cocking movement, the piston guide, together with the piston, is moved rearward in the opposing direction until the piston guide reaches a defined rear stop. When the device is pressed against a surface immediately prior to a driving operation, the piston and piston guide are now first moved further rearward together until the piston strikes a stop that may be displaced by means of the adjusting wheel. Thus, with further pressing, the piston remains where it is and only the piston guide is moved further rearward. The associated relative movement between the piston and the piston guide ultimately effects the aforementioned forward adjustment of the start position of the piston in the combustion chamber.

It is the object of the invention to provide a driving device that permits simple adjustment of a driving energy when there is a given propellant charge.

This object is inventively attained for an aforesaid driving device with the characterizing features of claim 1. By providing a slotted guide having a plurality of stop positions, the start position of the piston element may be changed in a simple manner in that the desired stop position on the slotted guide is selected.

Such an embodiment of axially different stop position furthermore has the advantage that it permits a linear or other desired adjusting scale for the driving energy, even if the association between start position and driving energy for the piston is quite non-linear.

A slotted guide in the context of the invention shall be construed to mean a component in which an axially oriented surface is provided, the axial position of which is different depending on a position perpendicular to the axial direction. This may involve steps, continuous ramps, or even a combination of steps and ramps. At least some of the axially different positions are provided as defined stop positions for adjusting the piston element.

A central axis in the context of the invention is an axis that is at least parallel to the movement of the fastening element. The central axis preferably also runs through a center of the fastening element and the piston element.

Driving energy in the context of the invention shall be construed to mean the kinetic energy of a given fastening means with a given propellant charge. If these basic conditions are met, the actuator makes it possible to adjustably change the resulting driving energy of the fastening means.

A piston element in the context of the invention is any means that is actuated with kinetic energy by the ignition of the charge, wherein the kinetic energy is ultimately transmitted onto the fastening means. Frequently the piston element is embodied in particular as a cylindrical piston. Recesses or other structures may be provided in the piston bottom that further promote vorticity and uniform expansion of the combustion gases. Preferably arranged on the piston element, especially at a piston head of the piston element, is a radially spaced, preferably pin-shaped projection that comprises a counterstop for the slotted guide. A fastening element in the context of the invention shall in general be construed to mean any drivable anchoring element, such as, for instance, a nail, bolt, or screw.

In one preferred embodiment of the invention, the slotted guide is pivotable about the central axis, so that a simple and space saving change in the stop position may be attained.

In general, the actuator has an operating part that is pivotable about the central axis. Due to the pivotability of the operating part about the central axis, simple displacement with concomitant effective visual control of the adjusted value may be attained. Such an arrangement also permits simple displacement, even under unfavorable conditions, such as, for instance, wearing work gloves. The operating part may be any means suitable for manual displacement, such as a rotatable sleeve, a pivotable knob, or the like.

A pivoting of the operating part about the central axis means an excursion of the operating unit, out of a previous position, essentially perpendicular to the axis. A movement line or trajectory of the operating part has a radius of curvature that is preferably not less than a distance between the operating part and the central axis. The pivot is preferably, but not necessarily, one rotation about the central axis.

In one simple realization, the operating part is coupled to the slotted guide via a mechanical positive control means. In a preferred refinement, via the positive control means, the operating part and the slotted guide are axially displaceable relative to one another and are connected to one another in a rotation-fast manner. This especially permits the position of the slotted guide to be axially changed relative to the housing during an adjustment of the piston position.

Generally advantageously, the operating part is embodied as an annular sleeve, wherein the sleeve encloses the central axis. For adjusting the driving energy, the sleeve may then be rotated into a plurality of different positions, wherein at least two different positions are allocated to two different driving energies.

For optimizing the ergonomics of the device, an inventive operating part and in particular a sleeve, described in the foregoing, may be arranged in a front area in front of a handle of the device. An advantageous analogy to known operating parts of manually guided drills and/or battery-operated screwdrivers may be drawn in terms of the arrangement and configuration of the operating part. The operating parts of such devices serve other purposes, for instance, adjusting torque or changing from screwing operation to hammer operation in a hammer drill.

In one generally preferred embodiment of the invention it is provided that the slotted guide is arranged on a sleeve element encircling the piston guide. Such a sleeve element is suitable for a simple mechanical realization that requires only little space. In particular, this may bridge an axial distance between slotted guide and an operating part for displacing the slotted guide.

It may be furthermore advantageously provided that the piston guide is axially displaced during the course of a pressing movement of the driving device relative to the slotted guide. This permits a space-saving and effective change in the start position of the piston element. During a pressing process, when the driving device is actuated, a front part of the device is pushed in by a certain travel distance, so that the corresponding relative movements of piston guide, piston element, and slotted guide are effected. Alternatively or in addition thereto, the adjustment of the start position of the piston element may also occur during the course of a cocking movement of the after a driving process.

One simple and effective realization of the invention provides that the piston element has a stop by means of which the piston element directly strikes one of the stop positions of the slotted guide during the course of the adjustment of its start position. This also keeps the number of components small.

Additional features and advantages of the invention result from the exemplary embodiment and the dependent claims. One preferred embodiment of the invention is described and explained in greater detail in the following using the attached drawings.

FIG. 1 is a side view of an inventive driving device;

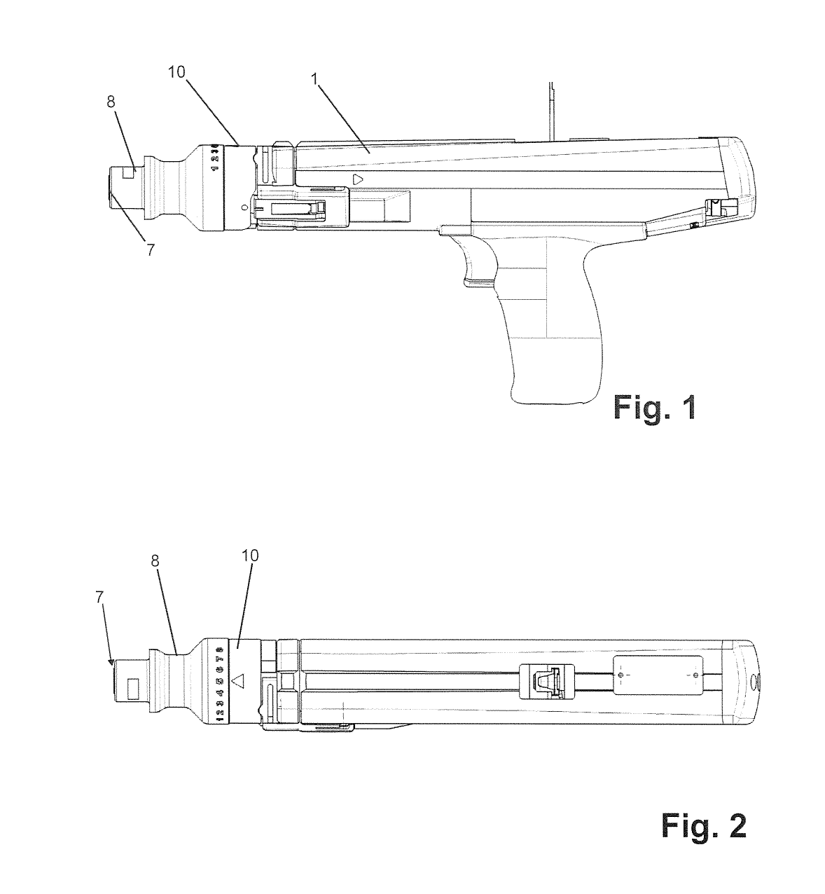

FIG. 2 illustrates the device from FIG. 1 in a top view from above;

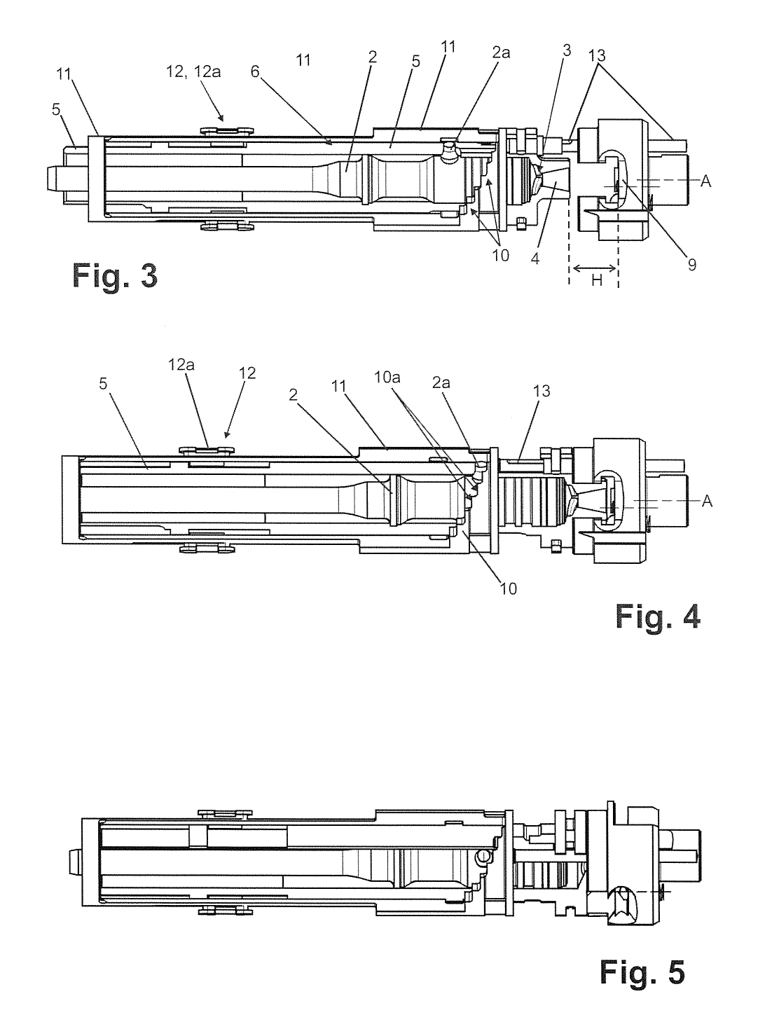

FIG. 3 depicts a cut-away spatial view of an interior area of the device from FIG. 1, wherein the device is not emplaced.

FIG. 4 depicts the view from FIG. 3, wherein the device is emplaced and a driving energy is adjusted to the maximum;

FIG. 5 depicts the view from FIG. 4, wherein the driving energy has been reduced by two steps;

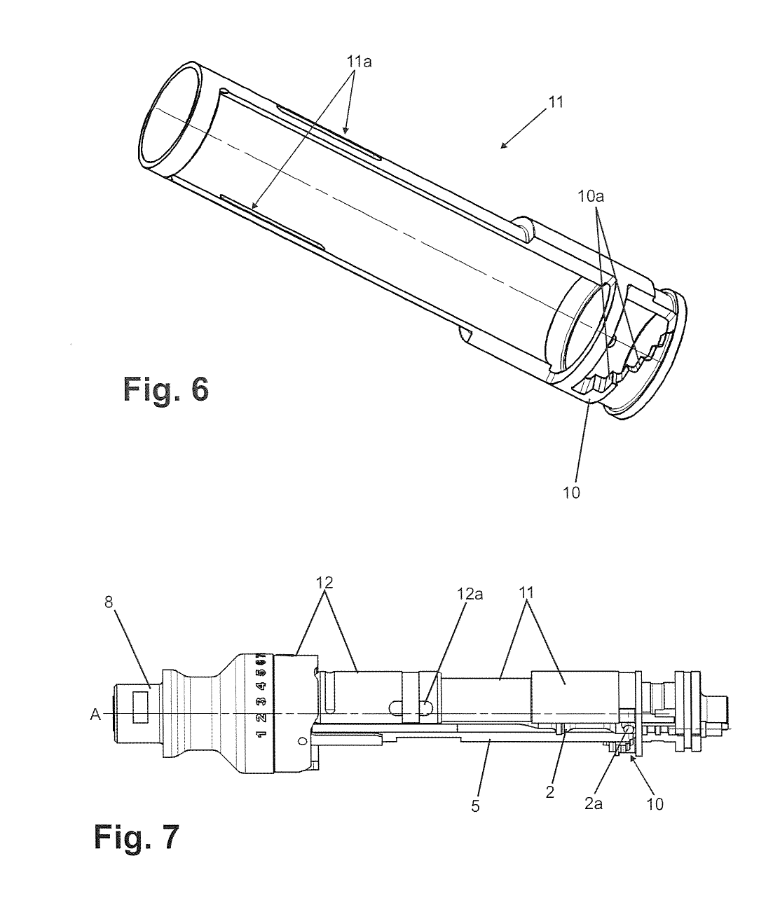

FIG. 6 depicts a spatial view of a slotted guide for the device from FIG. 3, which slotted guide is embodied on a sleeve element;

FIG. 7 depicts another cut-away spatial view of an interior area of the device from FIG. 1.

An inventive driving device comprises a manually guided housing 1 in which is accommodated a piston element in the form of a piston 2. A rear surface of the piston 2 delimits a combustion chamber 3 in which the combustion gases of a pyrotechnic charge expand in order to accelerate the piston 2.

The piston 2 thus actuated with kinetic energy strikes, with an end-face tappet, a fastening element (not shown), which is driven hereby into a workpiece.

The charge in this case is accommodated in a cartridge made of metal sheet. The cartridge has a percussion fuse and is placed into a cartridge bearing 4 prior to ignition using a corresponding charging unit. The cartridge and cartridge bearing 4 are embodied rotationally symmetrical about a central axis A. In the present exemplary embodiments, the central axis A is both a center axis of the combustion chamber 3 and of the piston element 2.

The combustion chamber 3 with the cartridge bearing 4 is a component of a piston guide 5. The piston guide 5 is embodied as a component that can be displaced linearly in the housing 1 of the driving device along the axis. The piston element 2 itself is linearly displaceable, along the central axis A, in the piston guide 5.

In its front area, the piston guide is shaped essentially as a hollow cylindrical element, wherein a slit 6 is provided in the wall of the piston guide 5 starting at an end of the area of the combustion chamber 3.

A front part 8 is connected to the piston guide 5. A seat element 7 for the fastening means is arranged in the front part 8. During the course of a driving process, the front piece 8 is emplaced on the workpiece and pushed against a spring force by a travel distance H (see FIG. 3). This presses the piston guide 5 with the cartridge bearing 4 rearward against a mechanical release 9 so that the cartridge can be ignited.

The piston element 2 comprises a stop in the form of a laterally projecting pin 2a that runs in the slit 6 of the piston guide 5. The pin 2a projects beyond the outer wall of the piston guide 5 and can strike one of a plurality of stop positions 10a of a slotted guide 10. Depending on the stop position, this adjusts a piston position in the piston guide 5 for the ignition time of the charge. A rear-most position of the piston element (see FIG. 4) corresponds to maximum driving energy. A position moved forward (see FIG. 5, moved forward by two steps) corresponds to a reduced driving energy.

By comparing FIG. 3 (non-emplaced) to FIG. 4 and FIG. 5 (emplaced), it may be seen that, after a cocking movement/piston re-set, the piston element 2 is first arranged in the rear-most position in the piston guide 5. The piston guide 5 is only moved further to the rear for the travel distance H of the emplacement, wherein the piston element 2, starting at an immediate stop of the pin 2a on the slotted guide 10, remains in the axial position.

The slotted guide 10 is embodied at a rear area of a sleeve element 11 and has the shape of a staircase curved circumferentially about the center axis. The individual steps or stop positions 10a are not of uniform height axially, but rather are adapted for linearizing an adjusting scale for the driving energy.

The sleeve element 11 encloses the piston guide 5 and may be both rotated around the latter and displaced axially relative to the latter. In a front area, the sleeve guide has two axially extending slits 11 a that are embodied for meshing with sliders 12a of an operating part.

The present operating part 12 is embodied as a rotatable, annular sleeve that is arranged essentially concentrically about the central axis A in a front area of the housing 1 of the driving device. The operating part is location-fast in the axial direction on the housing has a scale that indicates its position in the rotational direction. The sleeve element 11 is connected rotation-fast to the slotted guide 10 via the sliders 12a engaging in the slits 11 a, but is connected to the operating part 12 axially displaceable. The sliders 12a and the slits 11 a correspondingly embody a positive control means for connecting operating part 12 and slotted guide 10. Overall, the slotted guide 10, sleeve element 11, and operating part 12 embody an actuator for displacing the driving energy of the device.

For preparing a next driving process, the desired driving energy is adjusted as marked energy step on the operating part by rotating the sleeve 12. This leads, via the positive control means described in the foregoing, to a selected positioning of the slotted guide in the circumferential direction relative to the pin 2a of the piston element 2.

The actual relative positioning of the piston element 2 in the piston guide 5 then occurs as described in the foregoing in the course of the driving device being emplaced with corresponding pressing by the distance H. The sleeve element 11, with the slotted guide 10, is supported against a rear stop 13 that is location-fast to the housing 1. The stop 13 is pin-shaped in this case. A rear axial stop for the sleeve element 11 or the slotted guide 10 is necessary, since, in the present case, the slotted guide 10 is axially displaceable relative to the housing 1.

The inventive embodiment of a piston forward adjustment by means of a displaceable slotted guide is not limited to the exemplary embodiment described in the foregoing. Thus, for instance, there may be an alternative design in which the piston forward adjustment occurs before the course of the emplacement, that is, as early as during the course of the cocking movement.

1. A driving device, comprising:
a manually guided housing,
a piston guide,
a piston element accommodated in the piston guide for transmitting energy from a propellant charge onto a fastening element to be driven, wherein the piston element extends along a central axis (A), and
an actuator arranged for adjustably changing a start position of the piston element for changing the energy transmitted onto the piston element, wherein
the actuator comprises a slotted guide defining different stop positions of the piston element.

2. The driving device in accordance with claim 1, wherein the slotted guide is pivotable about the central axis (A).

3. The driving device in accordance with claim 1, wherein the actuator has an operating part that is pivotable about the central axis (A).

4. The driving device in accordance with claim 3, wherein the operating part is coupled to the slotted guide via a mechanical positive control.

5. The driving device in accordance with claim 4, wherein, via the positive control means, the operating part and the slotted guide are axially displaceable relative to one another, and are connected to one another in a rotation-fast manner.

6. The driving device in accordance with claim 3, wherein the operating part is an annular sleeve enclosing the central axis (A).

7. The driving device in accordance with claim 1, wherein the slotted guide is arranged on a sleeve element encircling the piston guide.

8. The driving device in accordance with claim 1, wherein the piston guide is axially displaced while pressing the driving device relative to the slotted guide.

9. The driving device in accordance with claim 1, wherein the piston element has a stop, and the piston element directly strikes one of the stop positions during adjustment of the start position.

10. The driving device in accordance with claim 2, wherein the actuator has an operating part that is pivotable about the central axis (A).

11. The driving device in accordance with claim 10, wherein the operating part is coupled to the slotted guide via a mechanical positive control.

12. The driving device in accordance with claim 11, wherein, via the positive control, the operating part and the slotted guide are axially displaceable relative to one another, and are connected to one another in a rotation-fast manner.

13. The driving device in accordance with claim 4, wherein the operating part is an annular sleeve enclosing the central axis (A).

14. The driving device in accordance with claim 5, wherein the operating part is an annular sleeve enclosing the central axis (A).

15. The driving device in accordance with claim 10, wherein the operating part is an annular sleeve enclosing the central axis (A).

16. The driving device in accordance with claim 11, wherein the operating part is an annular sleeve enclosing the central axis (A).

17. The driving device in accordance with claim 12, wherein the operating part is an annular sleeve enclosing the central axis (A).

18. The driving device in accordance with claim 2, wherein the slotted guide is arranged on a sleeve element encircling the piston guide.

19. The driving device in accordance with claim 2, wherein the piston guide is axially displaced while pressing the driving device relative to the slotted guide.

20. The driving device in accordance with claim 2, wherein the piston element has a stop, and the piston element directly strikes one of the stop positions during adjustment of the start position.
